(19) United States
(12) Patent Application Publication
(10) Pub. No.: US 2004/0060677 A1
(43) Pub. Date: Apr. 1, 2004

(54) Multi-functional paper and a method making the same

(76) Inventor: Ching-Chung Huang, Yunghe City (TW)

Correspondence Address: STRADLING YOCCA CARLSON & RAUTH,, IP Department, 660 Newport Center Drive, Suite 1600, P.O. Box 7680, Newport Beach, CA, 92660-6441, US

(21) Appl. No.: 10/259,242

(22) Filed: Sep. 27, 2002

(51) Int. Cl. A01G 7/00; D21H 17/00

(52) U.S. Cl. 162/158; 162/147; 162/55; 162/181.1; 162/164.1; 47/9; 47/58.1 SE; 162/161

(57) ABSTRACT

A method of manufacturing a multi-purpose functional agricultural mulching paper is disclosed. The method comprises steps of (a) providing a papermaking material, (b) treating the papermaking material to form a cleaned paper pulp, and (c) adding at least one functional additive into the cleaned paper pulp and treating the cleaned paper pulp to form the multi-purpose functional agricultural mulching paper. The multi-purpose functional agricultural mulching paper of the present invention can be applied in week control, pest control, bacterial control, plant disease control, growing seedling, fertilizer supply and seed sowing to increase the economic benefits.

The present invention relates to a paper and the manufacturing method therefor, and more particularly to a multi-purpose functional agricultural mulching paper and the manufacturing method therefor.

### BACKGROUND OF THE INVENTION

Generally the agricultural production comprises the steps of soil preparation, sowing, fertilization, hand weeding and harvest, each of which requires a huge amount of manpower. Particularly, the step of hand weeding is the most time-consuming process, which always delays the agricultural production for a period of time. To proceed the step of week control, the farmer conventionally covers a plastic film over the land to retard-the growth of weeds. However, after the crops are harvested, the farmer has no ideal in dealing with the useless plastic film. In addition, the plastic film can't be decomposed naturally so that it tends to result in environmental pollution and influence the ecological environment once the plastic film is discarded.

The paper product has the advantage of being decomposed in natural environment easily. After harvest, it can be naturally disintegrated and integrated as part of soil after plowing so that it would not cause any residual deleterious environmental impact as compared to those by traditional plastic film. Therefore, it is desired to develop an agricultural mulching paper to replace traditional plastic film, thereby improving the environmental pollution and increasing the economic benefits.

The paper is typically made of the organic wood fibers, which are also excellent carriers for microorganisms. However, conventional paper contains some chemical additives useless for agricultural planting. Thus the conventional paper is not suitable to be used in agricultural application.

It is therefore tried by the applicant to develop a multi-purpose functional agricultural mulching paper for applying in agricultural planting to solve the problems resulting from weed control, pest control, sowing, growing seedlings, fertilization, fertilizer saving and manpower saving, thereby increasing the economic benefits.

### SUMMARY OF THE INVENTION

It is therefore an object of the present invention to provide a multi-purpose functional agricultural mulching paper and the manufacturing method therefor.

It is further an object of the present invention to provide a multi-purpose functional agricultural mulching paper for applying in agricultural planting to control weeds, control pests, sow seeds, grow seedlings, supply fertilizer, save fertilizer and save manpower.

It is still an object of the present invention to provide a biodegradable agricultural mulching paper. The biodegradable agricultural mulching paper of the present invention have excellent light-blocking ability and natural porous carriers, thereby allowing antagonistic microorganisms to be coated thereon.

It is additional an object of the present invention to provide a method of manufacturing the multi-purpose functional agricultural mulching paper. The method comprises steps of (a) providing a papermaking material, (b) treating the papermaking material to form a cleaned paper pulp, and (c) adding at least one functional additive into the cleaned paper pulp and treating the cleaned paper pulp to form the multi-purpose agricultural mulching paper.

Preferably, the papermaking material is one selected from a group consisting of waste paper fibers, biodegradable plant fibers and polymer fibers.

In accordance with one aspect of the present invention, the step (b) comprises steps of classifying, pulp-dispersing, coarse pulp-clarifying, fiber-separation, coarse screening, fine pulp-clarifying, fine screening, heat-dispersion, bleaching, pulp-washing and pulp-refinning.

Preferably, the functional additive is one selected from a group consisting of Camellia seed cake, calcium carbonate, dry strength agent, wet strength agent, weed control agent, pest control agent and bacterial control agent.

Preferably, the Camellia seed cake is added into the cleaned paper pulp at. 1% for controlling the propagation of golden apple snails and increasing dispersion level of the pulp fibers.

Preferably, the calcium carbonate is added into the cleaned paper pulp at a usage based on the classification of the waste paper, sieving ratio of the fibers, desired water-absorbing ability and air permeability of the mulching paper for increasing the physical strength of the mulching paper and good for the multiplication of microorganisms.

Preferably, the weed control agent is various inorganic or organic filler selected from a group consisting of black carbon, silicon dioxide and titanium dioxide.

Preferably, the dry strength agent is one selected from a group consisting of melamine formaldehyde resin, polymeric amine-epichlorohydrin resin, phenoic resin, glyoxalated polyacrylamide resin, polyacrylamide resin, raw starch, modified starch, gelatine and various anionic or cationic acidic or neutral dry strength agent.

Preferably, the wet strength agent is one selected from a group consisting of melamine formaldehyde resin, polymeric amine-epichlorohydrin resin, phenoic resin, glyoxalated polyacrylamide resin and various anionic or cationic acidic or neutral wet strength agent.

Preferably, the multi-purpose functional agricultural mulching paper has a neutral pH value of about 6.

Preferably, the multi-purpose functional agricultural mulching paper has a basic weight ranged from 120 g/m² to 150 g/m² or above.

Preferably, the multi-purpose functional agricultural mulching paper has a thickness ranged from 0.2 mm to 0.3 mm.

Preferably, the multi-purpose functional agricultural mulching paper has a water-absorbing ability larger than Cobb, 1 Min, 20 gsm.

Preferably, the multi-purpose functional agricultural mulching paper has a wet-breaking strength in vertical/transverse lower than 1.0 kg/m² after two hours immersion.

Preferably, the multi-purpose functional agricultural mulching paper has an air permeability larger than a value of about 50 sec/100 cc.

In accordance with another aspect of the present invention, the multi-purpose functional agricultural mulching paper has light-blocking weed control ability and natural porous carriers suitable for microorganisms to breed therein so that antagonistic microorganisms for controlling diseases of the plants, pest control agent and bacterial control agent can be coated thereon.

Preferably, the antagonistic microorganisms for controlling diseases of the plants are rice sheath blight or radish seeding blight antagonistic microorganisms. More preferably, the pest control agent is selected from a group consisting of sodium dodecyl sulfate (SDS), linear alkyl sulfate (LAS), agricultural waste containing saponin, and methyl alcohol extracted from Camellia seed cake, or tobacco dust powder.

Certainly, the antagonistic microorganisms, pest control agent and bacterial control agent can be coated on the surface of the mulching paper by an adhesive material. Preferably, the adhesive material is one of natural amylum gel and carboxymethyl cellulose (CMC).

In accordance with another aspect of the present invention, the method further comprises a step of coating fertilizer powder or capsules on the mulching paper to form a slowly released organic or chemical fertilizer coating, thereby providing required nutrition for plants.

In accordance with another aspect of the present invention, the method further comprises a step of punching the mulching paper with plural holes, embossing the mulching paper with a pattern, and inlaying plural seeds in the punched holes to allow plural seeds to root downwardly when germination. Preferably, each of the punched holes slightly pierces through the fertilizer & microorganism coating and the mulching paper.

In accordance with another aspect of the present invention, the method further comprises a step of attaching a fixing layer on the mulching paper by an adhering material for securing plural seeds on the mulching paper. Preferably, the adhering material is one selected from a group consisting of glue spray, starch and carboxymethyl cellulose (CMC).

In accordance with another aspect of the present invention, the method further comprises a step of treating the seeds by a chemical agent cooperating with one selected from a group consisting of algin soda acid, gelatine and polyvinyl alcohol for protecting the germination of seeds. Preferably, the chemical agent is selected from a group consisting of ethylene glycol, propylene glycol, butylene glycol, polyethylene glycol, polypropylene glycol, polybutylene glycol, glycerine and 2-octyl glycol.

Preferably, the seeds are covered by paper pulp or polymer compound. More preferably, the seeds are seeds of cereal, seeds of medicinal herbs, seeds of economical plant, seeds of greensward, seeds of vegetables, seeds of flower, seeds of fruit or artificial seeds cultivated by cell organization.

Certainly, the multi-purpose agricultural mulching paper can be embossed with a pattern and punched with plural holes entirely to increase the water-absorbing ability, air permeability and softness thereof and dimension stability in paper size under the condition of dry and wet alternation.

Certainly, the functional additive can be selectively added into the cleaned paper pulp according to the requirements of the plants.

Certainly, the multi-purpose agricultural mulching paper can be rolled up and cut into a specific modeling for use.

Certainly, the multi-purpose agricultural mulching paper of the present invention can be used in large area field, home garden, golf field, cultivating box, indoor planting system and organic farming for planting various crops.

It is more an object of the present invention to provide a multi-purpose agricultural mulching paper. The multi-purpose agricultural mulching paper contains at least one functional additive and has a neutral pH value.

Preferably, the functional additive is one selected from a group consisting of seeds of Camellia seed cake, calcium carbonate, pest control agent, bacterial agent, weed control agent, dry strength agent and wet strength agent.

Preferably, the multi-purpose agricultural mulching paper has light-blocking weed control ability and natural porous carriers suitable for microorganisms to breed therein so that antagonistic microorganisms for controlling diseases of the plants, pest control agent and bacterial control agent can be coated thereon.

Preferably, the antagonistic microorganisms for controlling diseases of the plants are rice sheath blight or radish seeding blight antagonistic microorganisms.

Preferably, the pest control agent is one selected from a group consisting of sodium dodecyl sulfate (SDS), linear alkyl sulfate (LAS), agricultural waste containing saponin and methyl alcohol extracted from Camellia seed cake, or tobacco dust powder.

Certainly, the antagonistic microorganism, pest control agent and bacteria control agent can be coated on the surface of the mulching paper by an adhesive material. Preferably, the adhesive material is one of natural amylum gel and carboxymethyl cellulose (CMC).

Preferably, the mulching paper further comprises a slowly released organic or chemical fertilizer coating for providing required nutrition to plants and plural punched holes for allowing plural seeds to be inlaid therein. More preperably, the punched holes slightly pierces through the fertilizer and bacterial coating and mulching paper.

Preferably, the mulching paper further comprises a fixing layer attached on the surface thereof for fixing the seeds therein, wherein the fixing layer is attached on the surface by an adhesive material selected from a group consisting of spray glue, amylum and carboxymethyl cellulose (CMC).

The present invention may best be understood through the following descriptions with reference to the accompanying drawings, in which:

### BRIEF DESCRIPTION OF THE DRAWING

FIG. 1 is a schematic view showing a preferred multi-purpose agricultural mulching paper of the present invention.

### DETAILED DESCRIPTION OF THE PREFERRED EMBODIMENTS

The present invention shows a multi-purpose agricultural mulching paper for using in weed control, pest control, bacterial control, fertilizer supply and seed sowing. The mulching paper of the present invention is made of a papermaking material selected from the waste paper fibers, biodegradable plant fibers or polymer fibers.., etc. After the following papermaking process of pulp-dispersing, coarse pulp-clarifying, fiber-separation, coarse screening, fine pulp-clarifying, fine screening, heat-dispersion, bleaching, pulp-washing and pulp-refinning, the papermaking material becomes cleaned paper pulp and is fed to a papermaking machine to make the paper. Thereafter, the cleaned paper pulp is dehydrated by a pressing device of the papermaking machine, dried by a multicylinder dryer, and winding up to form a paper roll. The resulting paper is then rewinding up again, embossed with a pattern, punched with plural holes, inlaid with plural seeds, attached with a fixing layer, cut, and packed to form the multi-purpose agricultural mulching paper.

To meet the requirements of the multi-purpose agricultural mulching paper, various functional additives can be selectively added into the paper pulp during the papermaking process. These functional additives are preferably Camellia seed cake, calcium carbonate, dry strength agent, wet strength agent, weed control agent, pest control agent and bacteria control agent . . . , etc. Alternatively, these functional additives can be mixed with pulp slurry or sprayed, coated or immersed in the papermaking machine to allow the resulting mulching paper to meet the requirements of multi-purpose mulching paper.

If the multi-purpose agricultural mulching paper is applied in planting general crops, the wet strength agent is preferably one of the melamine formaldehyde resin, polymeric amine-epichlorohydrin resin, phenoic resin, glyoxalated polyacrylamide resin and various anionic or cationic acidic or neutral wet strength agent. In addition, the dry strength agent is preferably one of melamine formaldehyde resin, polymeric amine-epichlorohydrin resin, phenoic resin, glyoxalated polyacrylamide resin, polyacrylamide resin, raw starch, modified starch, gelatine and various anionic or cationic acidic or neutral dry strength agent.

With regard to weed control agent, various inorganic or organic packing material such as black carbon, silicon dioxide and titanium dioxide, may be the best choice. In addition, pest control agent is preferably linear alkyl benzene sulfonate or Camellia seed cake. Preferably, a little amount of calcium carbonate can be selectively added into the mulching paper according to the classification of the waste paper, sieving ratio of the fibers and desired water-absorbing ability and air permeability of the mulching paper, thereby increasing the physical strength of the paper, encouraging the breed of microorganisms and reduce pest control agent contains. More preferably, 1% natural Camellia seed cake can be added into the mulching paper for controlling the propagation of golden apple snails and increasing dispersion level of the fibers.

The present invention can be described more detailed according to the following manufacturing process and experimental data.

Besides classifying the waste paper in advance, the papermaking process of the present invention further employs a manufacturing equipment, which is able to generate cleaned paper pulp with high concentration and adjust the ratio of short and long fibers automatically according to Canadian Standard Freeness (CSF) of the paper pulp, to improve the structure of the fibers dispersed in the mulching paper. Therefore, the physical strength of the mulching paper can be enhanced up to a level of being applied in paddy field without adding any chemicals. In addition, the papermaking process of the present invention uses Wedgewire to sieve the paper pulp step by step so that the paper pulp can be sieved at an increasing amount under small slot. Moreover, certain particles, which may influence the quality of resulting paper and are unfavorable to the papermaking process and harmful to health, can be removed thoroughly. Certainly, the papermaking process of the present invention can also employ a 5% high concentration pulp-milling system to steady the papermaking process and the quality of resulting paper. Due to the absence of chemicals, the following steps of adjusting the ratio of fibers on machine direction and cross direction, steadying transverse basic weight, reducing dry temperature, reducing water gradient on machine direction and cross direction, by specific oven and anti-pollution equipment must be employed to maintain the physical strength, water-absorbing ability and air permeability of the mulching paper.

To improve the quality of the mulching paper, the mulching paper can be designed to have a basis weight ranged from 120 g/m² to 150 g/m² or above, thereby enhancing weed control ability and steadying other functions thereof. Preferably, the mulching paper has a thickness ranged from 0.2 mm to 0.3 mm. In addition, the water-absorbing ability of the mulching paper can be increased up to a level larger than Cobb, 1 Min, 20 gsm to allow the mulching paper to be covered on the paddy field more easily. To allow the rice seedlings to be sowed into the mulching paper and soil by rice transplanter more smoothly, the mulching paper can be designed to have a wet-breaking force in machine direction/cross direction lower than 1.0 kg/cm² after two hours immersion. To meet the requirements for dry land corps, the mulching paper of the present invention can be embossed with a pattern to have a air permeability degree larger than a value of 50 sec/100 cc so as to increase water-permeating ability and steady the variation in paper dimension under the conditions of wet and dry alternation.

In addition, one important characteristic of the agricultural mulching paper is that the papermaking process doesn't add any side effect chemicals into the mulching paper to maintain the pH value close to neutrality, thereby enhancing the activity of microorganisms and corps. To cooperate with the inoculation of antagonistic microorganisms, metal compound contained in the mulching paper must be controlled lower than a specific value according to the following Table 1 (According to Tappi Test Method T 438 cm-96).

TABLE 1

| Compound | Percentage (%) |
|---|---|
| Sodium oxide | 2.17 |
| Magnesium oxide | 3.43 |
| Aluminum oxide | 29.5 |
| Silicon oxide | 41 |
| Sulfur trioxide | 10.4 |
| Calcium oxide | 12.1 |
| Titania | 1.36 |
| Copper | 0.0027 |
| Chromium | 0.00071 |
| Nickel | 0.0033 |
| Iron | 0.06 |
| Manganese | 0.0026 |
| Lead | 0.01 |
| Zinc | 0.0075 |
| Mercury | ND* |
| Arsenic | ND |
| Total chromium | 0.00018 |

*ND means that the percentage of the metal compound is unable to be measured.

Besides above improvements in papermaking material, papermaking process, quality and function of the mulching paper, the present invention also takes advantage of the mulching paper's light-blocking weed control ability and natural porous carriers to encourage the breed of microorganisms. The mulching paper of the present invention can be coated with antagonistic microorganisms, natural pest control agent and bacterial control agent for controlling certain major diseases of the plants. The antagonistic microorganisms are preferably rice sheath blight or radish seeding blight antagonistic microorganisms. In addition, the pest control agent can be one of the sodium dodecyl sulfate (SDS), linear alkyl sulfate (LAS), agricultural waste containing saponin, and methyl alcohol extracted from Camellia seed cake,or tobacco dust powder. These antagonistic microorganisms, pest control agent, and bacterial control agent can be coated on the surface of the multi-purpose mulching paper by an adhesive material such as natural amylum gel or carboxymethyl cellulose (CMC).

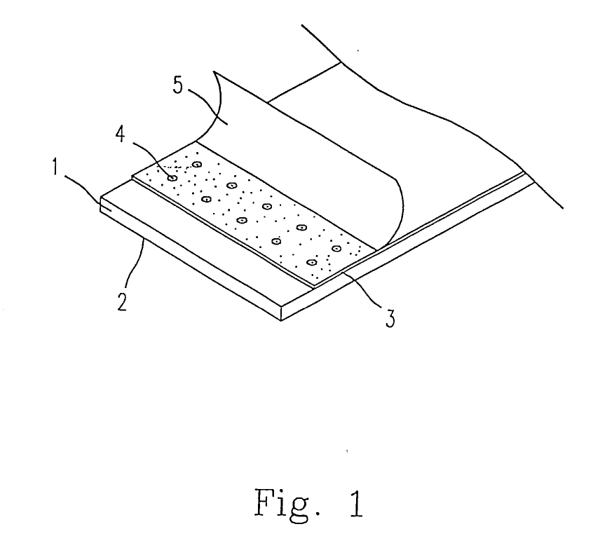

Please refer to FIG. 1 which is a schematic view showing the preferred mulching paper of the present invention. As shown in FIG. 1, SDS can be coated or sprayed on the back side of the mulching paper 1 to form a SDS coating 2. In addition, high concentration microorganism chlamydospores or conidia coating containing natural amylum gel and slowly released organic or chemical fertilizer coating 3 can be formed on the upper side opposite to the SDS coating 2. To allow the SDS coating 2 and microorganism chlamydospores or conidia coating remain on the surface of the mulching paper smoothly, the moisture contained in the mulching paper 1 can be overdried to a percentage of 5. Thereafter, high concentration microorganism chlamydospores or conidia containing natural amylum gel (10⁵ per ml) and 2000 ppm SDS are sprayed on <70° C. mulching paper to allow the water to be slightly evaporated and the mulching paper can reverse moisture content to 7˜8 % simultaneously. The mulching paper is then fed to a cooling roller for reducing the temperature of the mulching paper to <50° C., reeled up or cut to form an agricultural mulching paper.

In addition, a plurality of punched holes 4 can be formed in the mulching paper 1 for allowing the seeds to be inlaid therein. Preferably, each of the punched holes 4 slightly pierces through the organic or chemical fertilizer coating 3 and the mulching paper 1, thereby introducing the seeds therein to root downwardly when germination. Thereafter, various seeds can be inlaid in the punched holes 4 and a fixing layer 5 can be covered on the surface of the mulching paper 1 to allow the seeds to root downwardly and have healthy nurse-seed when germination. The fixing layer 5 is preferably a kitchen towel paper or tissue paper having a basic weight ranged from 13 to 35g/m². Preferably, the fixing layer 5 is attached to the surface of the mulching paper 1 by spraying an adhesive material such as starch or carboxymethyl cellulose (CMC). The resulting mulching paper is suitable to be applied in weed control, pest control, fertilizer supply and seeds sowing to form a four-in-one and multi-purpose functional agricultural mulching paper.

According to the properties of the crops and planting method therefor, one can employ one of the alginic soda acid, gelatine and polyvinyl alcohol to cooperate with a chemical agent for protecting the germination of the seeds. Preferably, the chemical agent is selected from a group consisting of ethylene glycol, propylene glycol, butylene glycol, polyethylene glycol, polypropylene glycol, polybutylene glycol, glycerine and 2-octyl glycol.

Certainly, the seeds or embryos artificial seed can be covered by paper pulp, polymer compound or pharmaceutical capsules. Preferably, the seeds are the seeds of cereal, seeds of medicinal herbs, seeds of economical plant, seeds of greensward, seeds of vegetables, seeds of flower, seeds of fruit or artificial seeds cultivated by embryonic callus or cell organization.

Alternatively, the organic or chemical fertilizer coating 3 can be coated on the lower layer of the mulching paper 1 or immerse in the mulching paper 1 according to the requirements of the crops. Certainly, the coatings of the present invention can be arranged in any sequence without being limited by the preferred embodiment of the present invention. After the organic or chemical fertilizer coating, the antagonistic microorganisms and SDS coating are respectively coated or sprayed on the mulching paper, the mulching paper can be further embossed with a pattern, punched with plural holes, inlaid with plural seeds therein and covered with a fixing layer to form the multi-purpose functional agricultural mulching paper. The step of pattern-embossing can not only steady the variation of paper dimension under the condition of dry and wet alternation but also increase the water-absorbing ability, permeable degree, air permeability and softness of the mulching paper. Therefore, the resulting mulching paper can be used more easily and effectively.

In summary, the multi-purpose functional agricultural mulching paper of the present invention can be applied in weed control, pest control, bacterial control, fertilizer supply and seed sowing to increase the economic benefits. In addition, the agricultural mulching paper of the present invention has the characteristics of being decomposed naturally. After harvest, it can be naturally disintegrated and integrated as part of soil after plowing so that it would not cause any residual deleterious environmental impact as compared to those by traditional plastic film. The multi-purpose agricultural mulching paper of the present invention can be applied in large area field, farm site, home garden, golf field, three-dimensional cultivating box containing organic soil and medium, indoor planting system with light-control and temperature-control apparatus, and organic farming for planting various crops. Certainly, the multi-purpose functional agricultural mulching paper of the present invention can also be reeled up or cut in various modeling for use.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What we claim is:

1. A method of manufacturing a multi-purpose functional agricultural mulching paper, comprising steps of:
(a) providing a papermaking material;
(b) treating said papermaking material to form a cleaned paper pulp; and
(c) adding at least one functional additive into said cleaned paper pulp and treating said cleaned paper pulp to form said multi-purpose functional agricultural mulching paper.

2. The method according to claim 1, wherein said papermaking material is one selected from a group consisting of waste paper fibers, biodegradable plant fibers and polymer fibers.

3. The method according to claim 2, wherein said step (b) comprises steps of classifying, pulp-dispersing, coarse pulp-clarifying, fiber-separation, coarse screening, fine pulp-clarifying, fine screening, heat-dispersion, bleaching, pulp-washing and pulp-refinning.

4. The method according to claim 3, wherein said at least one functional additive is one selected from a group consisting of Camellia seed cake's powder, calcium carbonate, dry strength agent, wet strength agent, weed control agent, pest control agent and bacterial control agent.

5. The method according to claim 4, wherein said Camellia seed cake's powder is added into said cleaned paper pulp at 1% for controlling the propagation of golden apple snails (Pomacea Canaliculata Lamarck) and increasing dispersion level of the fibers.

6. The method according to claim 4, wherein said calcium carbonate is added into said cleaned paper pulp at a usage based on the classification of said papermaking material, sieving ratio of the fibers, desired water-absorbing ability and air permeability of said mulching paper for increasing the physical strength of said mulching paper, encouraging the breed of microorganisms and decrease the pesticide of SDS or Camellia seed cake's powder consumption.

7. The method according to claim 4 wherein said weed control agent is various inorganic or organic packing material selected from a group consisting of black carbon, silicon dioxide and titanium dioxide.

8. The method according to claim 4, wherein said dry strength agent is one selected from a group consisting of melamine formaldehyde resin, polymeric amine-epichlorohydrin resin, phenoic resin, glyoxalated polyacrylamide resin, polyacrylamide resin, raw starch, modified starch, gelatine and various anionic or cationic acidic or neutral dry strength agent.

9. The method according to claim 4, wherein said wet strength agent is one selected from a group consisting of melamine formaldehyde resin, polymeric amine-epichlorohydrin resin, phenoic resin, glyoxalated polyacrylamide resin and various anionic or cationic acidic or neutral wet strength agent.

10. The method according to claim 1, wherein said multi-purpose functional agricultural mulching paper has a neutral pH value of about 6.

11. The method according to claim 1, wherein said multi-purpose functional agricultural mulching paper has basic weight ranged from 120 g/m² to 150 g/m² or above.

12. The method according to claim 1, wherein said multi-purpose functional agricultural mulching paper has a thickness ranged from 0.2 mm to 0.3 mm.

13. The method according to claim 1, wherein said multi-purpose functional agricultural mulching paper has a water-absorbing ability larger than Cobb, 1 Min, 20 gsm.

14. The method according to claim 1, wherein said multi-purpose agricultural mulching paper has a wet-breaking force in machine direction/cross direction lower than 1.0 kg/m² after two hours immersion.

15. The method according to claim 1, wherein said multi-purpose functional agricultural mulching paper has an air permeability larger than a value of about 50 sec/100 cc.

16. The method according to claim 1, wherein said multi-purpose functional agricultural mulching paper has light-blocking weed control ability and natural porous carriers suitable for microorganisms to breed therein so that antagonistic microorganisms for controlling diseases of the plants, pest control agent and bacterial control agent can be coated, sprayed or immersed thereon.

17. The method according to claim 16, wherein said antagonistic microorganisms for controlling diseases of the plants are one of the rice sheath blight (Rhizoctoria Solani <AG1>is one of the most important rice diseases) and radish seeding blight antagonistic microorganisms, and said pest control agent is selected from a group consisting of sodium dodecyl sulfate (SDS), linear alkyl sulfate (LAS), agricultural waste containing saponin and methyl alcohol extracted from Camellia seed cake or tobacco dust powder.

18. The method according to claim 16, wherein said antagonistic microorganism, said pest control agent and said bacterium control agent can be coated on the surface of said mulching paper by an adhesive material, wherein said adhesive material is one of natural amylum gel and carboxymethyl cellulose (CMC).

19. The method according to claim 16, wherein said method further comprises a step of coating fertilizer powder or capsules on said mulching paper to form a slowly released organic or chemical fertilizer coating, thereby providing required nutrition for plants.

20. The method according to claim 19, wherein said method further comprises a step of punching said mulching paper with plural holes, said mulching paper with a pattern, inlaying plural seeds in embossing said punched holes to allow said plural seeds to root downwardly when germination, wherein each of said punched holes slightly pierces through said fertilizer coating or immersing layer and said mulching paper.

21. The method according to claim 20, wherein said method further comprises a step of attaching a fixing layer on said mulching paper by an adhesive material for securing said plural seeds on said mulching paper, wherein said adhesive material is one selected from a group consisting of glue spray, starch and carboxymethyl cellulose (CMC).

22. The method according to claim 20, wherein said method further comprises a step of treating said seeds by a chemical agent cooperating with one selected from a group consisting of algin soda acid, gelatine and polyvinyl alcohol for protecting the germination of seeds, wherein said chemical agent is selected from a group consisting of ethylene glycol, propylene glycol, butylene glycol, polyethylene glycol, polypropylene glycol, polybutylene glycol, glycerine and 2-octyl glycol.

23. The mulching paper according to claim 20, wherein said seeds are selected from a group consisting of seeds covered by paper pulp, seeds covered by polymer compound, seeds of cereal, seeds of medicinal herbs, seeds of economical plant, seeds of greensward, seeds of vegetables, seeds of flower, seeds of fruit, seeds of forestry tree and artificial seeds cultivated by embryonic callus or cell organization.

24. The method according to claim 20, wherein said multi-purpose functional agricultural mulching paper can be embossed with a pattern and punched with plural holes entirely to increase the water-absorbing ability, air permeability and softness thereof and steady variation in paper dimension under the condition of dry and wet alternation.

25. The method according to claim 19, wherein said functional additive can be selectively added into said cleaned paper pulp according to the requirements of the plants.

26. The method according to claim 1, wherein said multi-purpose functional agricultural mulching paper can be rolled up and cut into a specific modeling for use.

27. The method according to claim 1, wherein said multi-purpose functional agricultural mulching paper is adapted to be used in large area field, farm site, forestry, home garden golf field, cultivating box, indoor planting system and organic farming for planting various crops.

28. A multi-purpose agricultural mulching paper comprising at least one functional additive and having a neutral pH value.

29. The mulching paper according to claim 28, wherein said at least one functional additive is one selected from a group consisting of Camellia seed cake powder or its extractives and derivtives, calcium carbonate, pest control agent, bacterial agent, weed control agent, dry strength agent and wet strength agent.

30. The mulching paper according to claim 29, wherein said Camellia seed cake powder is added into said mulching paper at 1% for controlling the propagation of golden apple snails (Pomacea Canaliculata Lamarck) and increasing dispersion level of the fibers; said calcium carbonate is added into said mulching paper with a dosage based on the classification of said papermaking material, sieving ratio of the fibers, desired water-absorbing ability and air permeability of said mulching paper for increasing the physical strength of said mulching paper and encouraging the breed of microorganisms, decreasing consumption of pest control agent; said weed control agent is various inorganic or organic filling material selected from a group consisting of black carbon, silicon dioxide and titanium dioxide; said dry strength agent is one selected from a group consisting of melamine formaldehyde resin, polymeric amine-epichlorohydrin resin, phenoic resin, glyoxalated polyacrylamide resin, polyacrylamide resin, raw starch, modified starch, gelatine and various anionic or cationic acidic or neutral dry strength agent; said wet strength agent is one selected from a group consisting of melamine formaldehyde resin, polymeric amine-epichlorhydrin resin, phenoic resin, glyoxalated polyacrylamide resin and various anionic or cationic acidic or neutral dry strength agent.

31. The mulching paper according to claim 28, wherein said mulching paper has a basis weight ranged from 120 g/m² to 150 g/m² or above, a thickness ranged from 0.2 mm to 0.3 mm, a water-absorbing ability larger than Cobb, 1 Min, 20 gsm, an air permeability larger than a value of above 50 sec/100 cc, and a wet-breaking force in machine direction/cross direction lower than 1.0 kg/m² after two hours immersion.

32. The mulching paper according to claim 28, wherein said multi-purpose functional agricultural mulching paper has light-blocking weed control ability and natural porous carriers suitable for microorganisms to breed therein so that antagonistic microorganisms for controlling diseases of the plants, pest control agent and bacterium control agent can be coated, sprayed or impregnated thereon.

33. The mulching paper according to claim 32, wherein said specific antagonistic microorganisms for controlling diseases of the plants are one of the rice sheath blight (Rhizoctoria Solani <AG1>is one of the most important rice diseases) and radish seeding blight antagonistic microorganisms; said pest control agent is one selected from a group consisting of sodium dodecyl sulfate (SDS), linear alkyl sulfate (LAS), agricultural waste containing saponin and methyl alcohol extracted from Camellia seed cake powder or tobacco dust powder; said antagonistic microorganisms, said pest control agent and said bacterial control agent can be coated, sprayed, impregnated on the surface of said mulching paper by an adhering material, wherein said adhesive material is one of natural amylum gel and carboxymethyl cellulose (CMC).

34. The mulching paper according to claim 32, wherein said mulching paper further comprises a slowly released organic or chemical fertilizer coating, spraying, impregnating or granuating for providing required nutrition to plants and plural punched holes for allowing plural seeds to be inlaid therein, wherein said punched holes slightly pierces through said fertilizer coating layer and mulching paper.

35. The mulching paper according to claim 34, wherein said mulching paper further comprises a fixing layer attached on the surface thereof for fixing said seeds therein, wherein said fixing layer is attached on said surface by an adhesive material selected from a group consisting of spray glue, amylum and carboxymethyl cellulose (CMC).

36. The method according to claim 34, wherein said seeds are treated by a chemical agent cooperating with one selected from a group consisting of algin soda acid, gelatine and polyvinyl alcohol for protecting the germination of seeds, wherein said chemical agent is selected from a group consisting of ethylene glycol, propylene glycol, butylene glycol, polyethylene glycol, polypropylene glycol, polybutylene glycol, glycerine and 2-octyl glycol.

37. The mulching paper according to claim 28, wherein said seeds are selected from a group consisting of seeds covered by paper pulp, seeds covered by polymer compound, seeds of cereal, seeds of medicinal herbs, seeds of economical plant, seeds of greensward, seeds of vegetables, seeds of flower, seeds of fruit, seeds of forestry tree and artificial seeds cultivated by embryonic callus or cell organization.

38. The method according to claim 28, wherein said multi-purpose functional agricultural mulching paper is adapted to be used in large area field, forestry, farm site, home garden, golf field, cultivating box, indoor planting system and organic farming for planting various crops.
